(19) United States
(12) Patent Application Publication
(10) Pub. No.: US 2024/0311728 A1
(43) Pub. Date: Sep. 19, 2024

(54) AIRCRAFT CONGESTION REDUCTION AT AIRPORT

(71) Applicant: The Boeing Company, Arlington, VA (US)

(72) Inventors: Umesh Kallappa Hosamani, Bangalore (IN); Akshay Arun Sankeshwari, Bengaluru (IN); Ajaya Srikanta Bharadwaja, Bangalore (IN); Veeresh Kumar Masaru Narasimhulu, Bangalore (IN)

(73) Assignee: The Boeing Company, Arlington, VA (US)

(21) Appl. No.: 18/183,436

(22) Filed: Mar. 14, 2023

(51) Int. Cl. G06Q 10/0633; G06Q 10/04; G06Q 50/30

(52) U.S. Cl. CPC G06Q 10/0633; G06Q 10/04; G06Q 50/40

(57) ABSTRACT

A system for aircraft congestion reduction on a ground at an airport includes a database, a computer, and a transmitter. The database is operational to store collected data gathered over at least a year at the airport. The computer is in communication with the database and is operational to train a machine learning model using the collected data, receive input data approximate a current time, and generate at the current time, based on the input data, the machine learning model, and a plurality of current aircraft, an estimated taxi time for a particular aircraft to move between an assigned gate and an assigned runway via an assigned route along the taxiways. The transmitter is in communication with the computer and is operational to transfer the estimated taxi time to the particular aircraft and a control center.

### TECHNICAL FIELD

The disclosure relates generally to aircraft scheduling, and in particular, to aircraft congestion reduction at an airport.

### BACKGROUND

Aircraft taxi operations are a significant source of energy consumption and emissions at airports. In a pilot study conducted at Boston Logan International Airport by researchers at the Massachusetts Institute of Technology; an estimated 4,000 tons of hydrocarbons, 8,000 tons of nitrogen oxides, and 45,000 tons of carbon monoxide were emitted through taxi-out operations at U.S. airports alone. The pollutants contribute to low-altitude emissions, directly impact local non-attainment of air pollution standards, and represent an endangerment to human health and welfare.

Accordingly, those skilled in the art continue with research and development efforts in the field of estimating taxi times on the ground at airports.

### SUMMARY

A system for aircraft congestion reduction on a ground at an airport is provided herein. The system includes a database, a computer, and a transmitter. The database is operational to store collected data gathered over at least a year at the airport. The collected data includes historical utilization information of a plurality of taxiways by a plurality of historical aircraft at the airport, historical departure information of the plurality of historical aircraft taking off from a plurality of runways at the airport, historical arrival information of the plurality of historical aircraft landing at the plurality of runways, and historical duration information of the plurality of historical aircraft to taxi between a plurality of gates at the airport and the plurality of runways. The computer is in communication with the database and is operational to train a machine learning model using the collected data, receive input data approximate a current time, and generate at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways. The input data includes a plurality of current positions of the plurality of current aircraft on the plurality of taxiways, a current departure information of the plurality of current aircraft taking off from the plurality of runways in a window of time after the current time, and a current arrival information of the plurality of current aircraft landing at the plurality of runways. The transmitter is in communication with the computer and is operational to transfer the estimated taxi time to the particular aircraft and a control center at the airport.

In one or more embodiments of the system, the estimated taxi time is an estimated taxi-in time from a runway departure from the assigned runway to a gate arrival at the assigned gate.

In one or more embodiments of the system, the estimated taxi time is an estimated taxi-out time from a gate departure from the assigned gate to a runway arrival at the assigned runway.

In one or more embodiments of the system, the computer is further operational to generate a score from a plurality of factors that influence an actual taxi time of the particular aircraft. The transmitter is further operational to transfer the score to the particular aircraft.

In one or more embodiments of the system, the input data includes the actual taxi time of the particular aircraft. The computer is further operational to record the input data while the particular aircraft is taxiing, and tune the machine learning model based on the actual taxi time and the input data as recorded.

In one or more embodiments of the system, the collected data includes a plurality of aircraft categories of the plurality of historical aircraft, a plurality of aircraft classifications of the plurality of historical aircraft, and a plurality of historical ages of the plurality of historical aircraft.

In one or more embodiments of the system, the input data includes a current aircraft category of the particular aircraft, a current aircraft classification of the particular aircraft, and a current age of the particular aircraft.

In one or more embodiments of the system, the collected data includes historical weather information, historical deicing information of the plurality of historical aircraft, and historical Notice to Air Missions information for the plurality of taxiways.

In one or more embodiments of the system, the input data includes current weather information, current deicing information of the particular aircraft, and current Notice to Air Missions information for the plurality of taxiways at the current time.

A method for reducing aircraft congestion on a ground at an airport is provided herein. The method includes storing in a database collected data gathered over at least a year at an airport. The collected data includes historical utilization information of a plurality of taxiways by a plurality of historical aircraft at the airport, historical departure information of the plurality of historical aircraft taking off from a plurality of runways at the airport, historical arrival information of the plurality of historical aircraft landing at the plurality of runways, and historical duration information of the plurality of historical aircraft to taxi between a plurality of gates at the airport and the plurality of runways. The method includes training with a computer a machine learning model using the collected data, receiving input data at the computer approximate a current time, generating with the computer at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways. The input data includes a plurality of current positions of the plurality of current aircraft on the plurality of taxiways, a current departure information of the plurality of current aircraft taking off from the plurality of runways in a window of time after the current time, and a current arrival information of the plurality of current aircraft landing at the plurality of runways. The method includes transferring with a transmitter the estimated taxi time to the particular aircraft and a control center at the airport.

In one or more embodiments of the method, the estimated taxi time is an estimated taxi-in time from a runway departure from the assigned runway to a gate arrival at the assigned gate.

In one or more embodiments of the method, the estimated taxi time is an estimated taxi-out time from a gate departure from the assigned gate to a runway arrival at the assigned runway.

In one or more embodiments, the method includes generating a score from a plurality of factors that influence an actual taxi time of the particular aircraft, and transferring the score to the particular aircraft.

In one or more embodiments, the method includes measuring the actual taxi time of the particular aircraft, recording the input data while the particular aircraft is taxiing, and tuning the machine learning model based on the actual taxi time and the input data as recorded.

In one or more embodiments of the method, the collected data includes a plurality of aircraft categories of the plurality of historical aircraft, a plurality of aircraft classifications of the plurality of historical aircraft, and a plurality of historical ages of the plurality of historical aircraft.

In one or more embodiments of the method, the input data includes a current aircraft category of the particular aircraft, a current aircraft classification of the particular aircraft, and a current age of the particular aircraft.

In one or more embodiments of the method, the collected data includes historical weather information, historical deicing information of the plurality of historical aircraft, and historical Notice to Air Missions information for the plurality of taxiways.

In one or more embodiments of the method, the input data includes current weather information, current deicing information of the particular aircraft, and current Notice to Air Missions information of the plurality of taxiways at the current time.

A method for reducing aircraft congestion on a ground at an airport is provided herein. The method includes storing in a database collected data gathered over at least a year at an airport. The collected data includes historical utilization information of a plurality of taxiways by a plurality of historical aircraft at the airport, historical departure information of the plurality of historical aircraft taking off from a plurality of runways at the airport, historical arrival information of the plurality of historical aircraft landing at the plurality of runways, and historical duration information of the plurality of historical aircraft to taxi between a plurality of gates at the airport and the plurality of runways. The method includes training with a computer a machine learning model using the collected data, receiving input data at the computer approximate a current time, and generating with the computer at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways. The input data includes a plurality of current positions of the plurality of current aircraft on the plurality of taxiways, a current departure information of the plurality of current aircraft taking off from the plurality of runways in a window of time after the current time, and a current arrival information of the plurality of current aircraft landing at the plurality of runways. The method includes generating a score from a plurality of factors that influence an actual taxi time of the particular aircraft, and transferring with a transmitter the estimated taxi time and the score to the particular aircraft.

In one or more embodiments of the method, the plurality of factors includes a busyness of ground traffic at the airport at the current time, the estimated taxi time, a complexity of the assigned route along the plurality of taxiways, current weather information, an estimated engine warm-up time, and an estimated flight disruption.

The above features and advantages, and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram of an airport in accordance with one or more exemplary embodiments.

FIG. 2 is a schematic diagram of a system in context in accordance with one or more exemplary embodiments.

FIG. 3 is a diagram of a time line of operation for the system in accordance with one or more exemplary embodiments.

FIG. 4 is a schematic plan diagram of a configuration of the airport at the current time in accordance with one or more exemplary embodiments.

FIG. 5 is a functional flow diagram of operations in of the system in accordance with one or more exemplary embodiments.

FIG. 6 is a flow diagram of a method for reducing aircraft congestion at the airport in accordance with one or more exemplary embodiments.

### DETAILED DESCRIPTION

Embodiments of the present disclosure include a system and/or a method for reducing aircraft congestion on the ground at an airport. The system and method utilize own aircraft data collected over a historical period, and applies a machine learning to predict accurate aircraft taxi times for a current situation (e.g., assigned runways, assigned taxi routes, accounting for weather, Notice to Air Missions (NOTAMs) information, surrounding traffic details, etc.). A model is built and initially trained over the historical period by monitoring historical data for aircraft using the airport to obtain analytics. The historical data generally includes, but is not limited to, the particular airport being used for the taxiing operations, assigned taxiways, taxi times, numbers of aircraft on the taxiways, numbers of aircraft landing/departing during a window of time, seasonal weather information, procedure specific information such as deicing criteria, Notice to Air Missions (e.g., closed taxiways), aircraft categories, aircraft classes, and aircraft ages. Once the model is initially trained, the model is fine-tuned with continuously collected historical data and additional input data. The trained and tuned model may be used at a current time in predicting how long a particular departing aircraft may take to taxi-out from an assigned gate, along an assigned taxiway route, to an assigned runway for departure. The trained and tuned model may also be used at the current time in predicting how long a particular arriving aircraft may take to taxi-in from an assigned landing runway, along an assigned taxiway route, to an assigned gate.

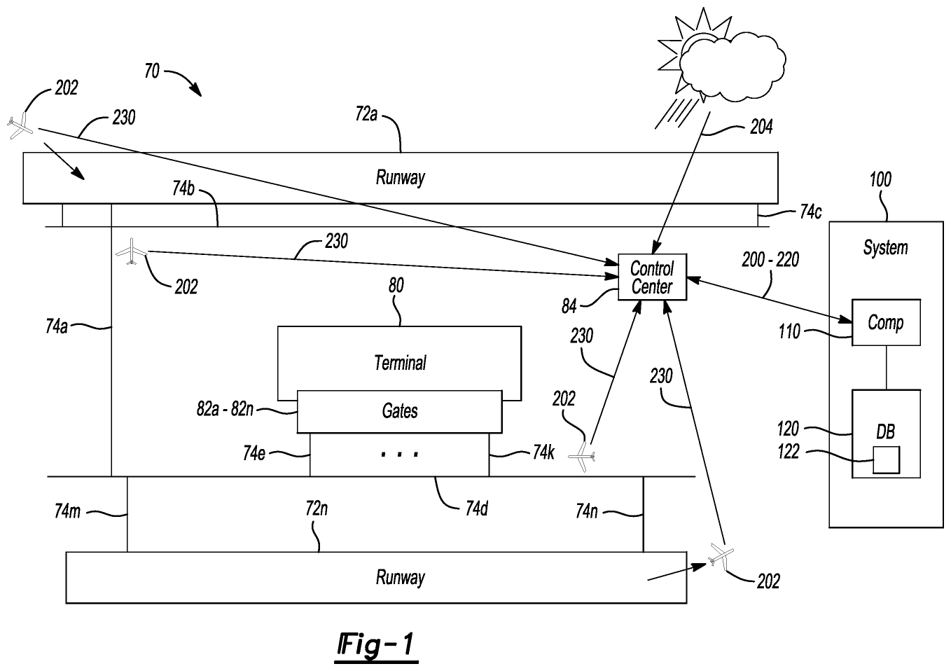

Referring to FIG. 1, a schematic plan diagram of an example airport 70 is shown in accordance with one or more exemplary embodiments. The airport 70 generally includes multiple runways 72a-72n, multiple taxiways 74a-74n, one or more terminals 80 (one shown), multiple gates 82a-82n, a control center 84, and a system 100. The system 100 includes one or more computers 110 (one shown) and one or more databases 120 (one shown). The databases 120 are operational to store collected data 122. The runways 72a-72n, the taxiways 74a-74n, and the terminals 80 may be disposed on a ground 76.

The collected data 122 generally includes historical airport data 200 gathered over at least one year by the system 100. The historical airport data 200 may include multiple historical aircraft 202 that have been at the airport 70, historical weather information 204, and historical NOTAM information 206 (e.g., closed taxiway information). Information collected for the historical aircraft 202 includes, but is not limited to, aircraft categories 208, aircraft classifications 210, historical ages 212, historical deicing information 214, historical engine warm-up times 216, historical utilization information 218 of the taxiways 74a-74n, historical duration information 220 that the historical aircraft 202 spent between the gates 82a-82n and the runways 72a-72n (e.g., taxiing in and taxiing out), historical departure information 222 of the historical aircraft 202 from the runways 72a-72n, and historical arrival information 224 of the historical aircraft 202 at the runways 72a-72n.

The data collection is a continuous process. Some data may be collected from the historical aircraft 202 via historical communications 230 with the control center 84. For example, the historical aircraft 202 may report actual times taken by the historical aircraft 202 to complete the taxi operations for assigned taxiways based on aircraft positions and speeds (e.g., the historical duration information 220). The historical aircraft 202 may also report the aircraft categories 208, the aircraft classifications 210, the historical ages 212, the historical deicing information 214, the historical engine warm-up times 216, and other specific information captured via input from the pilots.

Other data may be generated and/or collected by the control center 84. For example, air traffic controlled assigned taxiways 74a-74n, including assigned gates 82a-82n and runways information for the historical aircraft 202, the number and positions of the historical aircraft 202 on the taxiways 74a-74n (e.g., the historical utilization information 218), the number of historical arrival information 224 and the number of historical departure information 222, the historical weather information 204, and the historical NOTAM information 206 for the taxiways 74a-74n.

The data is collected initially over a time to cover the various seasons and different taxi conditions (e.g., >1 year) to build a model. Once the model is built, the model is used to predict taxi-times at a current time, and input data (e.g., newly collected data) is fed to the model for learning purposes.

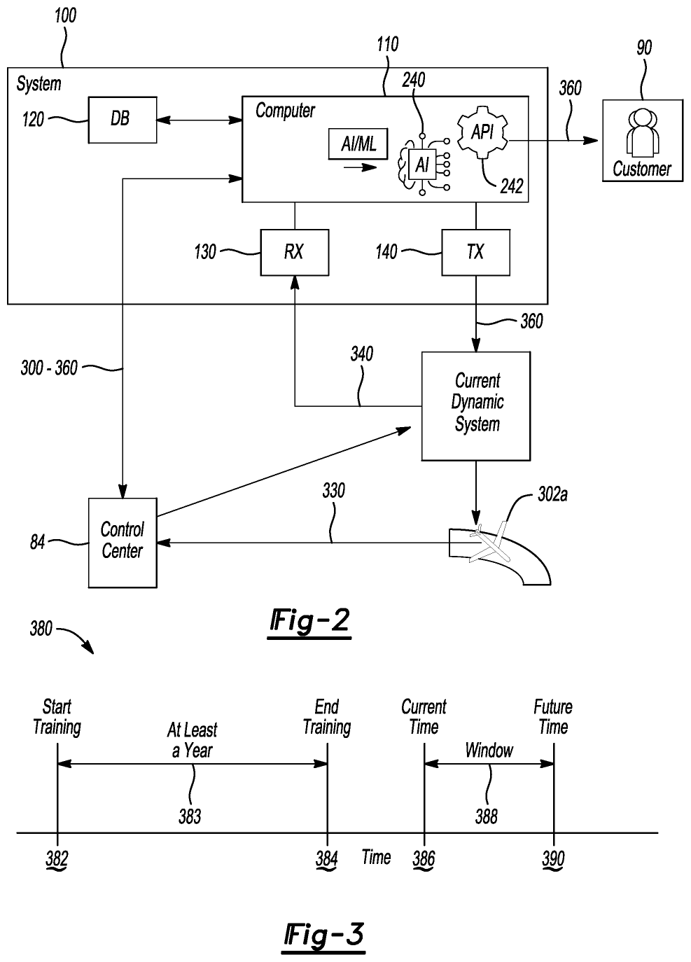

Referring to FIG. 2 and back to FIG. 1, a schematic diagram of an example implementation of the system 100 is shown in context in accordance with one or more exemplary embodiments. The system 100 generally includes the computer 110, the database 120, a receiver 130, and a transmitter 140. The computer 110 includes a machine learning (ML) model 240 and an application programming interface (API) block 242. Input data 300 is transferred from the control center 84 to the computer 110. The example describes a particular aircraft 302a among multiple current aircraft about to taxi at the airport 70. Current communications 330 are established between the particular aircraft 302a and the control center 84. The current communications 330 may be similar to the historical communications 230 between the historical aircraft 202 and the control center 84. An electronic flight bag 332 is located onboard the particular aircraft 302a and is operated by a crew member (e.g., a pilot) of the particular aircraft 302a. Electronic flight bag (EFB) data 340 may be received by the receiver 130 from the electronic flight bag 332.

The customer 90 implements one or more organizations with an interest in the operations of the airport 70 and the current aircraft. The customer 90 is operable to receive at least an estimated taxi time 360 of the particular aircraft 302a from the computer 110.

The computer 110 implements one or more data processing computers. The computer 110 is connected to the control center 84, the customer 90, the database 120, the receiver 130, and the transmitter 140. In embodiments with multiple computers 110, the individual computers 110 are coupled to share data, memory space, and processing resources. The computer 110 may be operational to build, train, and tune the machine learning model 240, and execute the application programming interface block 242. The computer 110 may receive the input data 300 from the control center 84. The EFB data 340 is received by the computer 110 from the electronic flight bag 332 via the receiver 130. The estimated taxi time 360 (e.g., taxi-in time or taxi-out time) may be generated by the computer 110. The estimated taxi time 360 is transferred back to the electronic flight bag 332 in the particular aircraft 302a via the transmitter 140. The estimated taxi time 360 is also transferred to the customer 90.

In various embodiments, the computer 110 may be configured by the software to perform one or more of a variety of operations in the system 100. The operations may include, but are not limited to, train the machine learning model 240 using the collected data 122, receive input data approximate a current time, generate at the current time, based on the input data 300 and the machine learning model 240 and multiple current aircraft, the estimated taxi time 360 for the particular aircraft 302a at the airport 70 to move between an assigned gate (e.g., 82a) of the multiple gates 82a-82n and an assigned runway (e.g., 72a) of the multiple runways 72a-72n via an assigned route along the taxiways 74a-74n. Other operations may be implemented to meet the design criteria of a particular application.

The receiver 130 implements a radio receiver device. The receiver 130 is in communication with the computer 110. The receiver 130 is operational to receive the EFB data 340 from the particular aircraft 302a.

The transmitter 140 implements a radio transmitter device. The transmitter 140 is in communication with the computer 110. The transmitter 140 is operational to transfer the estimated taxi time 360 to the particular aircraft 302a. In various embodiments, the receiver 130 and the transmitter 140 implement a single transceiver device. In other embodiments, the receiver 130 and the transmitter 140 are implemented as separate devices.

The machine learning model 240 implements a model built and trained based on the historical airport data 200 (e.g., training data) in order to make predictions of the estimated taxi times 360 at a current time after the historical airport data 200 has been processed. The machine learning model 240 may utilize the training, the input data 300, and the EFB data 340 at the current time for the predictions.

The application programming interface block 242 implements a communication block. The application programming interface block 242 is operational to facilitate communications between the computer 110 and the customer 90. In various embodiments, the application programming interface block 242 may transfer the estimated taxi time 360 from the computer 110 to the customer 90. Other data may be transferred to meet the design criteria of a particular application.

The electronic flight bag 332 implements a portable information management device. The electronic flight bag 332 is operational to assist flight crews to perform flight management tasks, provide reference material, display information received from the control center 84 to the flight crew, and communicate the EFB data 340 from the flight crew to the system 100. The information received from the control center 84 generally includes current dynamic data, such as current weather information and current NOTAM information. The EFB data 340 may include, but is not limited to, actual taxi times and pilot-reporting information.

Referring to FIG. 3, a diagram of an example time line 380 of operation for the system 100 is shown in accordance with one or more exemplary embodiments. The time line 380 include a training start time 382 and a training end time 384. The training start time 382 indicates a beginning to data collection for the airport 70. The training end time 384 generally occurs a duration (e.g., at least a year 383) after the training start time 382. Collecting data for at least a year 383 allows for various seasons, various weather conditions, and a large number of historical aircraft 202 to fly into, taxi around at, and fly away from the airport 70.

A current time 386 may occur after the training end time 384. The current time 386 generally indicates the time when an estimated taxi time 360 is generated for the particular aircraft 302a (FIG. 2). The estimated taxi time 360 may be based in part on current arrival information for the current aircraft expected to land at the various runways 72a-72n within a window of time 388. The window of time 388 generally extends from the current time 386 to a future time 390. The window of time 388 may be in the range of a few minutes (e.g., 10 minutes) to several tens of minutes (e.g., 30 minutes).

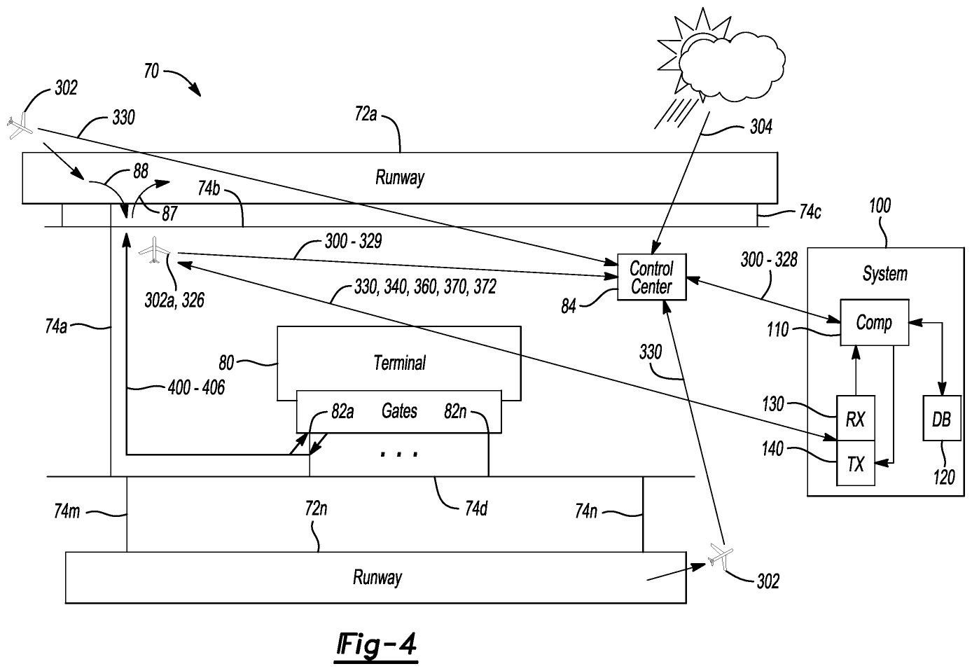

Referring to FIG. 4, a schematic plan diagram of an example configuration of the airport 70 at the current time 386 is shown in accordance with one or more exemplary embodiments. At the current time 386, multiple current aircraft 302 may be at (e.g., on the ground 76) or near (e.g., soon to land at) the airport 70. The system 100 is operational to generate the estimated taxi time 360 (FIG. 2) for the particular aircraft 302a. As illustrated, the particular aircraft 302a may be expected to taxi 400 (e.g., taxi-out movement 404) starting with a gate departure 86 from a particular gate (e.g., 82a), along a particular route 406 that involves one or more particular taxiways (e.g., 74a), until a runway arrival 87 onto a particular runway (e.g., 74a). From the particular runway 72a, the particular aircraft 302a may take off and leave the airport 70. In other situations, the particular aircraft 302a may land on the particular runway 72a. Once landed, the particular aircraft 302a may be expected to taxi 400 (e.g., taxi-in movement 402) from a runway departure 88 off the particular runway 72a, along the particular route 406 on the particular taxiway 74a, until a gate arrival 89 at the particular gate 82a.

The input data 300 at a current time 386 generally includes number of current aircraft 302 at or near the airport 70, current weather information 304, current NOTAM information 306 (e.g., closed taxiway information), current aircraft categories 308, current aircraft classifications 310, current ages 312, current deicing information 314, estimated engine warm-up times 316, current utilization information 318 of the taxiways 74a-74n, current duration information 320 that the current aircraft 302 are spending between the gates 82a-82n and the runways 72a-72n (e.g., estimated taxi-in times 362 and estimated taxi-out times 364), current departure information 322 of the current aircraft 302 taking off from the runways 72a-72n in the window of time 388 starting from the current time 386 (FIG. 3), current arrival information 324 of the current aircraft 302 at the runways 72a-72n in the window of time 388 starting from the current time 386, current positions 326 of the current aircraft 302 on the taxiways 74a-74n, and estimated flight disruptions 328.

The communications 330 from the current aircraft 302 to the control center 84 generally includes current aircraft categories 308, current aircraft classifications 310, current ages 312, current deicing information 314, estimated engine warm-up times 316, and other specific information captured via input from the flight crew. The EFB data 340 may include the actual taxi time 370 and pilot-reporting information 372.

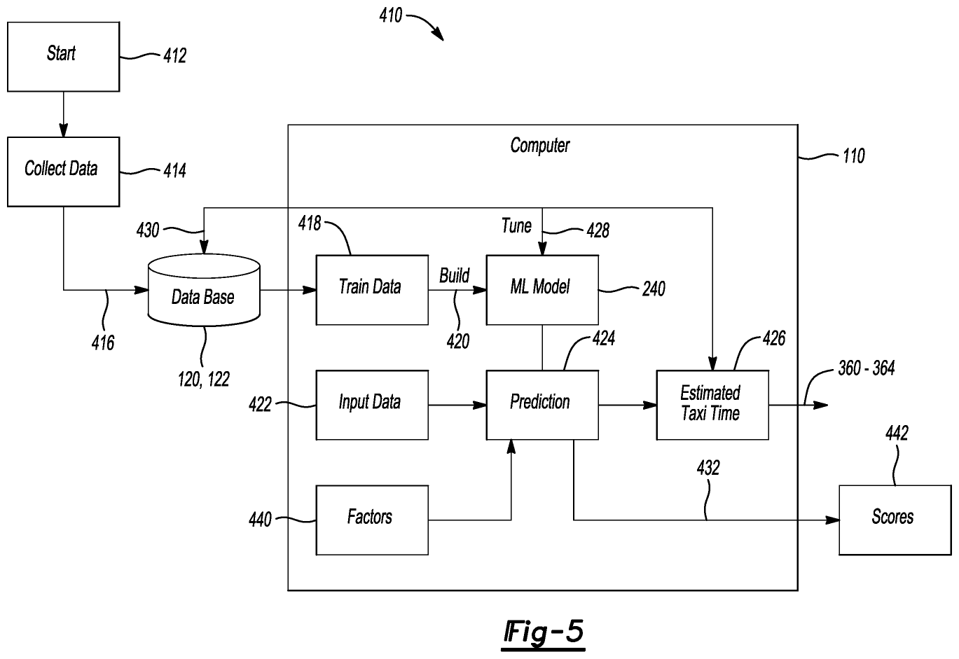

Referring to FIG. 5 and back to FIGS. 1-4, a functional flow diagram of example operations 410 in the system 100 is shown in accordance with one or more exemplary embodiments. The operation (or process) 410 may be implemented by the system 100. The operation 410 includes steps 412 to 432, as illustrated. The sequence of steps is shown as a representative example. Other step orders may be implemented to meet the criteria of a particular application.

In the step 412, the operation 410 begins at the collection start time 382. The collected data 122 may be collected in the step 414 and stored in the database 120 in the step 416 for the at least a year 383 to take into account the seasonal impacts. During the at least a year 383, the collected data 122 may be read from the database 120 in the step 418. The collected data 122 is used as training data in the step 420 to build the machine learning model 240.

At an end of the at least a year 383 (e.g., at the training end time 384), the machine learning model 240 may be ready to aid in predicting taxi times. At a current time 386 after the training end time 384, the input data 300 is gathered in the step 422. The input data 300 is applied to the machine learning model 240 to predict the estimated taxi time 360 in the step 424 for the particular aircraft 302a. The estimated taxi time 360 (e.g., estimated taxi-in time 362 or estimated taxi-out time 364) is presented to the particular aircraft 302a and to the control center 84 in the step 426. The estimated taxi time 360 is used in the step 428 to tune the machine learning model 240. The estimated taxi time 360 may also be stored in the database 120 as new collected data 122 in the step 430. A score 442 may be calculated as part of the prediction step 424 in response to multiple factors 440. The score 442 is reported to the particular aircraft 302a in the step 432.

The estimated taxi time 360 may be used in determining a reduced-engine taxi verses a full-engine taxi operation as follows. The reduced-engine taxi operation depends on the various factors 440 along with the taxi time. Each factor 440 is assigned a weight from which a total weight is calculated. For example, the factors 440 may include, but are not limited to, airport traffic, taxi time, taxiway complexity, weather, engine warmup, and flight disruption details. For the airport traffic, busyness of ground traffic 329 at the airport 70 at the current time 386 has a high weightage. Higher predicted (e.g., history data for a given situation) taxi time has a high weightage. Complex taxiway turns for a taxi in/taxi out have a moderate weightage. An increased friction coefficient for a taxiway 74a-74n due to the weather have high weightage. Less estimated time consumed for engine warm up carries a high weightage. Flight disruptions generally carry a medium weightage. Based on a combined weight of the factors 440, the score 442 is determined. A high score 442 indicates a reduced-engine taxi operation. A low score 442 indicates a full-engine taxi operation. The input data 300 and various aircraft schedule data may also be captured to aid in predicting the future.

The system 100 uses the historical airport data 200 to estimate taxi-out times 364 for the current conditions, and so accurately predicts the estimated taxi-out times 364. For example, where the estimated taxi-out time 364 may be long (e.g., at least 30 minutes), the pilot may decide to use reduced-engine taxiing directly resulting in less fuel burn, and indirectly resulting in lower-altitude emissions.

Accurately predicting estimated taxi-in time 362 helps in arranging ground operations. Where the estimated taxi-in time 362 is reasonably known, flexibility is granted to ground control operators in assigning gates 82a-82n, ground resources, making push back plans, and the like. The flexibility helps in efficient utilization of ground resources and/or in avoiding delays.

Efficient taxi-time prediction helps to eliminate delays and improve the utilization of resources. Where estimated taxi time 360 is accurately predicted in advance; operators gain a flexibility that allows adjustments to schedules, gate assignments, and push back plans. The flexibility achieves smoother operations of ground movement at the airport 70, reduces surface congestion, and reduces fuel-burn costs by planning upfront. Hence, accurate prediction of the estimated taxi time 360 is a precondition for improving the operationality of the departure process at an airport 70, as well as reducing the long taxi-time, congestion, and excessive emission of greenhouse gases.

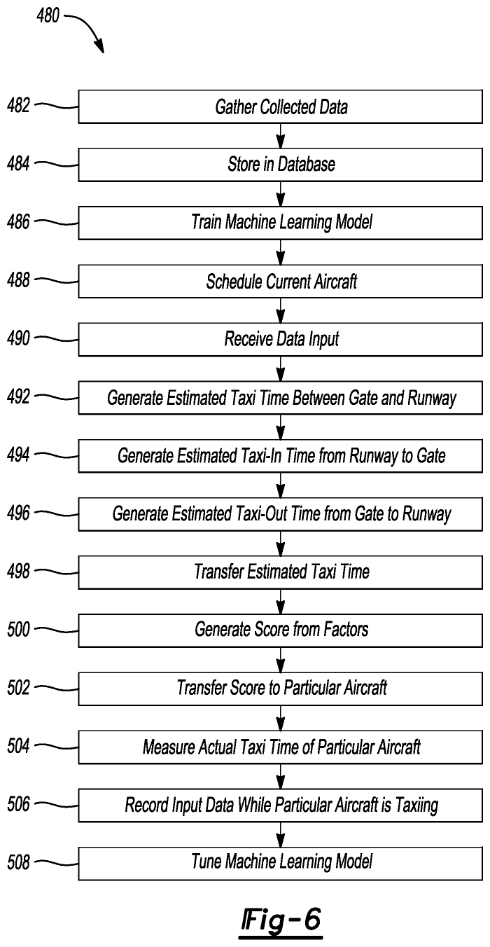

Referring to FIG. 6, a flow diagram of an example method 480 for reducing aircraft congestion on the ground 76 at an airport 70 is shown in accordance with one or more exemplary embodiments. The method 480 (or process) is implemented by the historical aircraft 202, the current aircraft 302 at the airport 70, the control center 84, and the system 100. The method 480 includes the steps 482 to 508, as illustrated. The sequence of steps is shown as a representative example. Other step orders may be implemented to meet the criteria of a particular application.

In the step 482, the collected data 112 is gathered over at least a year 383 at the airport 70. The collected data 112 is stored in the database in the step 484. The machine learning model 240 is trained in the step 486 using the collected data 112.

In the step 488, the current aircraft 302 at and near the airport 70 are scheduled from the control center 84. The input data 300 is received at the computer 110 approximate the current time 386 in the step 490. At the current time 386, based on the input data 300, the machine learning model 240, and the current aircraft 302, the computer 110 generates an estimated taxi time 360 for the particular aircraft 302a to move between the assigned gate 82a and the assigned runway 72a via the assigned route 406 along the taxiways 74a-74n in the step 492.

In an arrival at the airport 70 case, the computer 110 may generate an estimated taxi-in time 362 in the step 484 from the runway departure 88 from the assigned runway 72a until the gate arrival 89 at the assigned gate 82a. In a departure from the airport 70 case, the computer 110 may generate an estimated taxi-out time 364 in the step 496 from the gate departure 86 from the assigned gate 82a until the runway arrival 87 at the assigned runway 72a. Once on the assigned runway 72a, the particular aircraft 302a may take flight to leave the airport 70. In the step 498, the estimated taxi time 360 may be transferred to the particular aircraft 302a and the control center 84 with the transmitter 140 in the system 100.

In the step 500, the computer 110 may generate a score 442 from multiple factors 440 that influence the actual taxi time 370 of the particular aircraft 302a. The score 442 is transferred in the step 502 from the system 100 to the particular aircraft 302a. The actual taxi time 370 of the particular aircraft 302a may be measured in the step 504. Furthermore, the database 120 may record the input data 300 in the step 506 while the particular aircraft 302a is taxiing. Thereafter, the machine learning model 240 may be tuned in the step 508 based on the actual taxi time 370 and the input data 300 as recorded.

Because the system 100 accounts for aircraft-own data and other dynamic conditions, like traffic, weather, NOTAM information, and the like, the estimated taxi time 360 may be accurate, even in busy airports. The accurate estimated taxi time 360 helps in making smart decision by the pilots and airliner authorities, which in turn, helps to reduce congestion on the taxiways. For example, the estimated taxi time 360 helps streamline scheduling by predicting gate push back time. The reduced congestion aids in reducing carbon foot prints and fuel burn costs. In another example, the pilots may make good decisions on using reduced-engine taxiing. The estimated taxi time 260 helps eliminate delays and improves the utilization of resources. In turn, the improvements enable smooth operation of an airport ground movement and reduces surface congestion and fuel-burn costs.

This disclosure is susceptible of embodiments in many different forms. Representative embodiments of the disclosure are shown in the drawings and are herein described in detail with the understanding that these embodiments are provided as an exemplification of the disclosed principles, not limitations of the broad aspects of the disclosure. To that extent, elements and limitations that are described, for example, in the Abstract, Background, Summary, and Detailed Description sections, but not explicitly set forth in the claims, should not be incorporated into the claims, singly or collectively, by implication, inference or otherwise.

For purposes of the present detailed description, unless specifically disclaimed, the singular includes the plural and vice versa. The words “and” and “or” shall be both conjunctive and disjunctive. The words “any” and “all” shall both mean “any and all”, and the words “including,” “containing,” “comprising,” “having,” and the like shall each mean “including without limitation.” Moreover, words of approximation such as “about,” “almost,” “substantially,” “approximately,” and “generally,” may be used herein in the sense of “at, near, or nearly at,” or “within 0-5% of,” or “within acceptable manufacturing tolerances,” or other logical combinations thereof. Referring to the drawings, wherein like reference numbers refer to like components.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for aircraft congestion reduction on a ground at an airport comprising:
a database operational to store collected data gathered over at least a year at the airport,
wherein the collected data includes
historical utilization information of a plurality of taxiways by a plurality of historical aircraft at the airport,
historical departure information of the plurality of historical aircraft taking off from a plurality of runways at the airport,
historical arrival information of the plurality of historical aircraft landing at the plurality of runways, and
historical duration information of the plurality of historical aircraft to taxi between a plurality of gates at the airport and the plurality of runways;
a computer in communication with the database and operational to:
train a machine learning model using the collected data,
receive input data approximate a current time, and
generate at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways,
wherein the input data includes
a plurality of current positions of the plurality of current aircraft on the plurality of taxiways,
a current departure information of the plurality of current aircraft taking off from the plurality of runways in a window of time after the current time, and
a current arrival information of the plurality of current aircraft landing at the plurality of runways; and
a transmitter in communication with the computer and operational to transfer the estimated taxi time to the particular aircraft and a control center at the airport.

2. The system according to claim 1, wherein the estimated taxi time is an estimated taxi-in time from a runway departure from the assigned runway to a gate arrival at the assigned gate.

3. The system according to claim 1, wherein the estimated taxi time is an estimated taxi-out time from a gate departure from the assigned gate to a runway arrival at the assigned runway.

4. The system according to claim 1, wherein:
the computer is further operational to generate a score from a plurality of factors that influence an actual taxi time of the particular aircraft, and
the transmitter is further operational to transfer the score to the particular aircraft.

5. The system according to claim 4, wherein
the input data includes the actual taxi time of the particular aircraft, and
the computer is further operational to:
record the input data while the particular aircraft is taxiing; and
tune the machine learning model based on the actual taxi time and the input data as recorded.

6. The system according to claim 1, wherein the collected data includes
a plurality of aircraft categories of the plurality of historical aircraft,
a plurality of aircraft classifications of the plurality of historical aircraft, and
a plurality of historical ages of the plurality of historical aircraft.

7. The system according to claim 6, wherein the input data includes
a current aircraft category of the particular aircraft,
a current aircraft classification of the particular aircraft, and
a current age of the particular aircraft.

8. The system according to claim 1, wherein the collected data includes
historical weather information,
historical deicing information of the plurality of historical aircraft, and
historical Notice to Air Missions information for the plurality of taxiways.

9. The system according to claim 8, wherein the input data includes
current weather information,
current deicing information of the particular aircraft, and
current Notice to Air Missions information for the plurality of taxiways at the current time.

10. A method for reducing aircraft congestion on a ground at an airport comprising:
storing in a database collected data gathered over at least a year at an airport,
wherein the collected data includes
historical utilization information of a plurality of taxiways by a plurality of historical aircraft at the airport,
historical departure information of the plurality of historical aircraft taking off from a plurality of runways at the airport,
historical arrival information of the plurality of historical aircraft landing at the plurality of runways, and
historical duration information of the plurality of historical aircraft to taxi between a plurality of gates at the airport and the plurality of runways;
training with a computer a machine learning model using the collected data;
receiving input data at the computer approximate a current time,
generating with the computer at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways,
wherein the input data includes
a plurality of current positions of the plurality of current aircraft on the plurality of taxiways,
a current departure information of the plurality of current aircraft taking off from the plurality of runways in a window of time after the current time, and
a current arrival information of the plurality of current aircraft landing at the plurality of runways; and
transferring with a transmitter the estimated taxi time to the particular aircraft and a control center at the airport.

11. The method according to claim 10, wherein the estimated taxi time is an estimated taxi-in time from a runway departure from the assigned runway to a gate arrival at the assigned gate.

12. The method according to claim 10, wherein the estimated taxi time is an estimated taxi-out time from a gate departure from the assigned gate to a runway arrival at the assigned runway.

13. The method according to claim 10, further comprising:
generating a score from a plurality of factors that influence an actual taxi time of the particular aircraft; and
transferring the score to the particular aircraft.

14. The method according to claim 13, further comprising:
measuring the actual taxi time of the particular aircraft;
recording the input data while the particular aircraft is taxiing; and
tuning the machine learning model based on the actual taxi time and the input data as recorded.

15. The method according to claim 10, wherein the collected data includes
a plurality of aircraft categories of the plurality of historical aircraft,
a plurality of aircraft classifications of the plurality of historical aircraft, and
a plurality of historical ages of the plurality of historical aircraft.

16. The method according to claim 15, wherein the input data includes
a current aircraft category of the particular aircraft,
a current aircraft classification of the particular aircraft, and
a current age of the particular aircraft.

17. The method according to claim 10, wherein the collected data includes
historical weather information,
historical deicing information of the plurality of historical aircraft, and
historical Notice to Air Missions information for the plurality of taxiways.

18. The method according to claim 17, wherein the input data includes
current weather information,
current deicing information of the particular aircraft, and
current Notice to Air Missions information of the plurality of taxiways at the current time.

19. A method for reducing aircraft congestion on a ground at an airport comprising:
storing in a database collected data gathered over at least a year at an airport,
wherein the collected data includes
historical utilization information of a plurality of taxiways by a plurality of historical aircraft at the airport,
historical departure information of the plurality of historical aircraft taking off from a plurality of runways at the airport,
historical arrival information of the plurality of historical aircraft landing at the plurality of runways, and
historical duration information of the plurality of historical aircraft to taxi between a plurality of gates at the airport and the plurality of runways;
training with a computer a machine learning model using the collected data;
receiving input data at the computer approximate a current time;
generating with the computer at the current time, based on the input data, the machine learning model, and a plurality of current aircraft at and near the airport, an estimated taxi time for a particular aircraft among the plurality of current aircraft to move between an assigned gate of the plurality of gates and an assigned runway of the plurality of runways via an assigned route along the plurality of taxiways,
wherein the input data includes
a plurality of current positions of the plurality of current aircraft on the plurality of taxiways,
a current departure information of the plurality of current aircraft taking off from the plurality of runways in a window of time after the current time, and
a current arrival information of the plurality of current aircraft landing at the plurality of runways; and
generating a score from a plurality of factors that influence an actual taxi time of the particular aircraft; and
transferring with a transmitter the estimated taxi time and the score to the particular aircraft.

20. The method according to claim 19, wherein the plurality of factors includes
a busyness of ground traffic at the airport at the current time,
the estimated taxi time,
a complexity of the assigned route along the plurality of taxiways,
current weather information,
an estimated engine warm-up time, and
an estimated flight disruption.
